(19) United States
(12) Patent Application Publication
(10) Pub. No.: US 2024/0179520 A1
(43) Pub. Date: May 30, 2024

(54) SECURE COMMUNICATION SYSTEM AND METHOD

(71) Applicant: Jerry K. Joseph, Washington, DC (US)

(72) Inventor: Jaipal Singh Paul, Silver Spring, MD (US)

(21) Appl. No.: 18/518,128

(22) Filed: Nov. 22, 2023

Related U.S. Application Data
(60) Provisional application No. 63/427,960, filed on Nov. 25, 2022.

(51) Int. Cl. H04W 12/06; H04W 12/47; H04W 12/63

(52) U.S. Cl. CPC H04W 12/06; H04W 12/47; H04W 12/63

(57) ABSTRACT

A method of authenticating a user to provide communication between communication devices. The method includes affixing an identifying means to a fixed or non-fixed, specific location. The method further includes scanning, using a first mobile device corresponding to a first user, the identifying means affixed to the location. In response to scanning of the identifying means, sending, using the first mobile device a communication request to a second mobile device corresponding to a second user via a network. The method further includes selectively authenticating, using the second mobile device, the first mobile device for communication.

### CROSS-REFERENCE

This application claims priority to provisional application No. 63/427,960, filed on Nov. 25, 2022, and all the benefits accruing therefrom under 35 U.S.C. § 119, the contents of which in its entirety are herein incorporated by reference.

### BACKGROUND OF THE INVENTION

### 1. Field of the Invention

The present general inventive concept relates to devices, systems, and methods for notifying a property owner that another individual is in the vicinity of the property and more particularly devices, systems, and methods to allow remote authentication and audio and video communications without the need of external cameras or other doorbell related hardware.

### 2. Description of Related Art

There have been previous devices and systems that have been developed for notifying a property owner that another individual is in the vicinity of the property. However, these devices and systems are often expensive and require communication hardware in connection with a structure on the property. This hardware often requires maintenance and updates to associated software.

Therefore, what is desired is a system and method for notifying a property owner that another individual is in the vicinity of the property, that eliminates the problems associated with the prior art, and that enables the identity of the user recipient or property owner to remain confidential as desired.

### SUMMARY OF THE INVENTION

The present general inventive concept provides a method of authenticating a user to provide communication between mobile devices. The method includes affixing a QR code to a fixed or non-fixed, specific location. That is, the location can be a specific non-fixed location, but is restricted thereto. The method further includes scanning, using a first mobile device corresponding to a first user, the QR code affixed to the location. In response to scanning of the QR code, sending, using the first mobile device, a communication request to a second mobile device corresponding to a second user via a network. The method further includes selectively authenticating, using the second mobile device, the first mobile device for communication.

The method may include affixing at least one of a radio frequency identification (“RFID”) reader or an RFID tag to the fixed location. The first mobile device may include the other of the RFID reader and RFID tag.

The method may include scanning, using the RFID reader, a unique identifier associated with the RFID tag, and in response to scanning of the unique identifier, sending, using the first mobile device the communication request to the second mobile device.

The RFID reader and the RFID tag may be configured to communicate via near field communication (“NFC”).

The communication between the first mobile device and the second mobile device may be at least one of an audio call, a video call, or messaging.

The method may include masking identifying data associated with at least one of the first mobile device and the second mobile device.

The method may include, subsequent to sending of the communication request from the first mobile device to the second mobile device, enabling the second mobile device to deny the communication request such that the first mobile device is not authenticated for communication.

The communication between the first mobile device and the second mobile device may be established using a smart device software application accessible via at least one of the first mobile device and the second mobile device.

The present general inventive concept alternatively provides a method of authenticating a user to provide communication between mobile devices including affixing an identifying means to a fixed location. The method may further include scanning, using a first mobile device corresponding to a first user, the identifying means affixed to the location and in response to scanning of the identifying means, sending, using the first mobile device a communication request to a second mobile device corresponding to a second user via a network. The method may further include selectively authenticating, using the second mobile device, the first mobile device for communication.

The identifying means may be at least one of a QR code, an RFID tag, or an RFID reader.

The first mobile device may include at least one scanning device such as a camera, an RFID tag, or an RFID reader.

The communication between the first mobile device and the second mobile device may be at least one of an audio call, a video call, or messaging.

The method may include masking identifying data associated with at least one of the first mobile device and the second mobile device.

Communication between the first mobile device and the second mobile device may be established using a smart device software application accessible via at least one of the first mobile device and the second mobile device.

The present general inventive concept alternatively provides a system for authenticating a user to provide communication between mobile devices. The system may include an identifying means in operative connection with a fixed location. The system may include a first mobile device corresponding to a first user that is configured to scan the identifying means. The system may further include a second mobile device corresponding to a second user, that is configured to accept or deny communications from the first mobile device. In the system, responsive to scanning the identifying means, the first mobile device is configured to send a communication request to the second mobile device via a network. In response to receipt of the communication request, the second user is enabled to accept or deny the communication request via at least one input to the second mobile device, and the first mobile device is authenticated for communication upon acceptance of the request.

The identifying means may be a QR code, an RFID tag, an RFID reader, or a combination thereof.

The first mobile device may include at least one scanning device, such as a camera, an RFID tag or RFID reader.

The communication between the first mobile device and the second mobile device may be an audio call, a video call, or messaging.

The first mobile device and the second mobile device may be configured to mask identifying data associated therewith.

Communication between the first mobile device and second mobile device may be established using a smart device software application accessible via at least one of the first and second mobile devices.

### BRIEF DESCRIPTIONS OF THE DRAWINGS

These and/or other aspects of the present general inventive concept will become apparent and more readily appreciated from the following description of the embodiments, taken in conjunction with the accompanying drawings of which:

FIG. 1 is a schematic of an exemplary mobile doorbell communication system and method according to an exemplary embodiment; and

FIG. 2 is a continuation of the schematic in FIG. 1.

### DESCRIPTION OF INVENTION

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

According to an example embodiment of the present general inventive concept, the method provides a means for authenticating a first mobile device corresponding to a first user and establishing communication between the first mobile device and a second mobile device, particularly arranged as a mobile doorbell communication system. However, the present general inventive concept is not limited thereto.

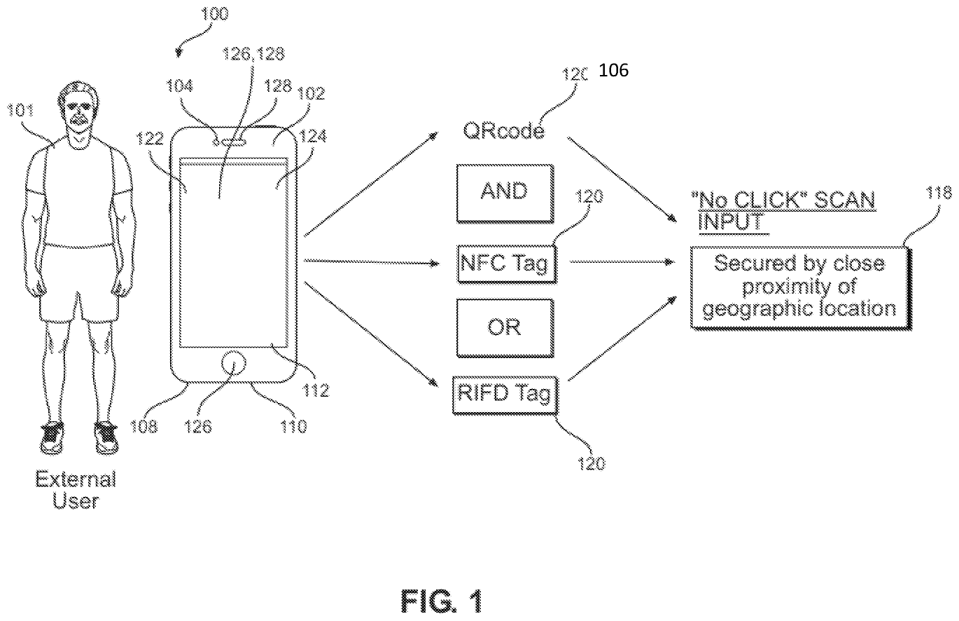

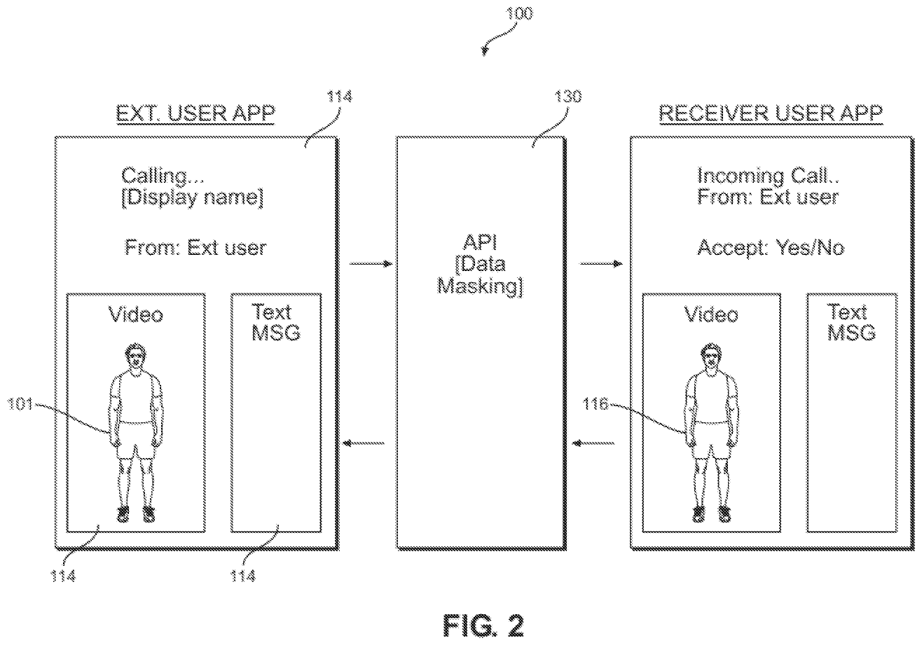

Referring to FIGS. 1-2, the exemplary mobile doorbell communication system, designated generally as 100, is illustrated. In the exemplary embodiment, the mobile doorbell communication system 100 is designed and configured as a mobile doorbell communication system that eliminates the need for expensive communication hardware and enables the identity of the property owner to remain confidential when desired. That is, the mobile doorbell communication system 100 is designed to notify a property owner that another individual is in the vicinity of the property without the need for a doorbell, doorbell camera, or other hardware. However, the present general inventive concept is not limited thereto.

In an exemplary embodiment, a method for authenticating a user to provide communication between mobile devices is provided. The method includes affixing an identifying means to a fixed, or non-fixed location. The method further includes scanning, using a first mobile device corresponding to a first user, the identifying means affixed to the location. In response to scanning of the QR code, sending, using the first mobile device a communication request to a second mobile device corresponding to a second user via a network. The method further includes selectively authenticating, using the second mobile device, the first mobile device for communication.

In an exemplary embodiment, the mobile doorbell communication system 100 includes an external user or first user 101 which utilizes a remote electronic device or mobile device 102 that includes a scanning device 104 such as camera. The scanning device or camera 104 is configured to capture an image or scan an identifying means 106, such as a QR code. However, the present general inventive concept is not limited thereto.

The exemplary mobile device 102 includes a processor 108 and a memory 110. Exemplary memory 110 is operative to store a copy of system software 112. System software 112 includes instructions executable by processor 108 for achieving the operations and functions of the exemplary arrangements, embodiments, and methods described herein. The present general inventive concept is not limited thereto.

In response to the scanning of identifying means or QR code 106, the exemplary processor 108 is operative to execute the processor readable instructions of the system software 112 to authenticate the first mobile device 102 and to establish a communication channel 114 between mobile device 102 of the first user 101 and a mobile device 102 of a second user, such as a property owner 116. In such embodiments, the identifying means 106 is affixed to a fixed location of the property of the second user 116. However, the present general inventive concept is not limited thereto.

In alternative embodiments, the identifying means 106 may be fixed to other locations as well. Such locations may be non-fixed, specific locations. In still other alternative embodiments, the identifying means 106 may be fixed to moveable or mobile locations or objects. However, the present general inventive concept is not limited thereto.

In alternative embodiments, the system software 112 authenticates the first mobile device 102 through data or information associated with the mobile device 102, and read by the system software 112. The system software 112 is configured to determine whether the mobile device 102 corresponds to a known individual or user. In alternative embodiments, when the system software 112 does not determine that the mobile device 102 corresponds to a known individual or user, the system software may request an authentication determination by the second user 116 via a user interface of the system software 112 before the communication channel 114 can be established.

For example, upon scanning of the identifying means 106 via the mobile device 102 associated with the first user 101, the system software 112 is configured to send a communication request to the mobile device 102 of the second user 116. Upon receipt of the communication request by the second user 116, the second user 116 is enabled to manually or vocally make at least one input into the interface of the system software 112 on the second user's mobile device 116 to accept the communication request. Upon acceptance of the communication request, the first user 101 and the second user 116 are enabled to communicate via their mobile devices 102 in real time either through an audio call, a video call, or through a messaging platform. Upon confirmation by the second user 116 that the first user 101 is an individual allowed to access the property, the second user 116 may authenticate the first user 101 for access to the property. However, the present general inventive concept is not limited thereto.

In exemplary embodiments, the second user 116 comprises at least one of an individual, a human, or an entity who owns the property, who resides at the property, who has authority to make decisions at the property, who is renting the property, or any other individual or entity. Of course, the second user 116 may comprise a connected computer system tasked with monitoring access to the property.

In exemplary embodiments, the communication between the first mobile device 102 and the mobile device of the second user may be an audio call, a video call, or messaging. That is, the communication channel 114 comprises at least one of a text messaging communication, an audio call communication, or a video communication, or any combination thereof. However, the present general inventive concept is not limited thereto.

In alternative exemplary embodiments, the identifying means 106 may include a radio frequency identification (“RFID”) tag or reader/scanner. In such embodiments, the first mobile device 102 includes at least one of the RFID tag or reader, and the second mobile device 102 associated with the second user 116 includes the other of the RFID tag or reader. The RFID tag or reader may be configured to communicate using near field communication (“NFC”). That is, a communication channel 114 may be established between the mobile devices of the first user 101 and the property owner 116 through RFID and/or NFC.

In alternative embodiments, the RFID tag and reader capabilities may be accessed or downloaded onto a memory of the mobile devices 102 via the system software 112 or through use of another smart device software application.

In such embodiments using RFID communication or NFC, the exemplary system and method includes an RFID or NFC reader or scanning device 118 in operative connection with a structure or portion of the property associated with the second user 116. The mobile device 102 of the first user 101 includes an RFID or NFC tag 120. However, in alternative arrangements, the mobile device 102 may include the reader or scanning device 118, and the tag 120 is affixed in operative connection with a structure or fixed location of the property owner 116. However, the present general inventive concept is not limited thereto.

In exemplary embodiments, when the tag 120 is moved into close proximity or contacting relation with the scanning or reading device 118, an exchange or transfer of data takes place between the reader 118 and the tag 120 via associated antennas, transceivers, transponders, and/or microchips of the mobile devices 102. Thereafter, the processor 108 of the mobile device 102 associated with the first user 101 is operative to execute the processor readable instruction of the system software 112 to send a communication request or establish a communication channel between the mobile device 102 of the user 101 and the mobile device 102 associated with the property owner 116. However, the present general inventive concept is not limited thereto.

In exemplary embodiments, the exemplary communication channel 114 is established through a user interface 122 of the system software 112. For example, the exemplary system software 112 may comprise a smart device application and be offered through application marketplaces such as Apple®, Android®, or Microsoft® app stores. In exemplary arrangements, the exemplary system software 112 is executed by the processor of mobile device 102 of the first user 101 as well as the processor of the mobile device 102 associated with the property owner 116. The present general inventive concept is not limited thereto.

In exemplary embodiments, mobile device 102 includes a display screen 124, an input device 126, and an output device 128. The first user 101 and the second user 116 are enabled to interact with the system software 112 through the user interface 122 using the display screen 124, input device 126, and output device 128.

In exemplary embodiments, the exemplary system software 112 is configured to provide one of the communications channels 114 previously discussed. The first user 101 and the second user 116 are enabled to communicate in real time using the communication channel 114.

In alternative embodiments, the exemplary system software 112 may connect to other smart device applications to establish the communication channel 114. The exemplary system software 112 may achieve this by using application programming interfacing (“API”). For example, once the image of the QR code has been captured by the camera 104 (or other identifying means has been scanned) of the mobile device 102, the system software 112 may connect with other software or applications stored on the user's device or otherwise accessible via the user's mobile device 102 to establish the communication channel 114. The other software or applications may include, but are not limited to, messaging, audio, or video applications of Apple® or Android®, WhatsApp®, Facebook Messaging®, SnapChat®, or Instagram®. However, the general inventive concept is not limited thereto.

In alternative embodiments, system 100 may require a combination of identifying means 106 including a QR code and a proximity reading between the tag 120 and the reader 118 before the communication channel 114 will be established. The present general inventive concept is not limited thereto.

In alternative embodiments, the present general inventive concept may mask any identifying data or information associated with at least one of the mobile devices of the first and second users. That is, the exemplary system software 112 may further include processor executable instructions for masking the data or other identifying information associated with the first user 101, the second user 116, and their associated mobile devices 102. For example, system 100 includes a data masking component 130. However, system software 112 may be configured to connect with other software through API to execute the data masking function.

As an example, after the first user 101 has scanned the identifying means 106, the system software may mask any identifying data or information associated with the first user 101, the second user 116, and their associated mobile devices 102. In this way, the identity of the first user 101 and the second user 116 remain confidential. Of course, for efficiency purposes, the first user 116 may select certain phone numbers or individuals to never be masked, such family. In some embodiments, the second user 116 may set system 100 rules in which any time a first user 101 sends a communication request where the first user's information is masked, the system 100 automatically denies to communication request. This may be useful for individuals who prefer a higher degree of privacy at their property. However, the present general inventive concept is not limited thereto.

In an exemplary application, the system 100 may be used in an exemplary method 1000. The exemplary method begins at begins at step 1002. At step 1004 a first user 101 in close geographical proximity of property owned by a second user or property owner 116 is enabled to scan a QR code operatively affixed to a structure of the property by capturing an image of the QR code with the scanning device 104, such as a camera of a mobile device 102 associated with the first user 101. However, the present general inventive concept is not limited thereto.

In alternative exemplary methods, at step 1002, an RFID tag 120 or NFC tag 120 in operative connection with the first user's mobile 102 is moved within close geographical proximity of an RFID or NFC scanner or reader 118, and a transfer of data or information takes place between the tag 120 and the scanner 118. In other alternative methods, at step 1002, the first user 101 may be required to use one or more identifying means including, for example, both scanning the QR code and establishing a data transfer between the scanner 118 and the tag 120. However, the present general inventive concept is not limited thereto.

At step 1004, responsive to the scanned QR code or the transfer of information between the tag 120 and scanner or reader 118, a communication channel 114 is established between the mobile device 102 of the first user 101 and a mobile device 102 associated with the second user 116. The present general inventive concept is not limited thereto.

At step 1006, the second user 116 is enabled to accept or deny the communication from the first user 101. The present general inventive concept is not limited thereto.

At step 1008, if the second user 116 has selected to accept the communication from the first user 101, the communication channel 114 is established and the first user 101 and the second user 116 may communicate. However, if the second user 116 denies the communication, a communication channel 114 is not established. The present general inventive concept is not limited thereto.

In alternative methods, before the communication channel 114 is established, a data masking function is executed in which no information about the first user 116 or its associated mobile device 102 is provided to the first user 101. The present general inventive concept is not limited thereto.

In alternative embodiments, the system 100 may further include an electronic lock. In such embodiments, upon authentication of the first user 101 by the second user 116 for access to the property, the system 100 may send a signal or message to the electronic lock to change the lock to an unlocked position in which the first user 101 is enabled to access the property. However, the present general inventive concept is not limited thereto.

In alternative embodiments, the system 100 is configured to establish the communication channel 114 only when the QR code is scanned via a camera of the mobile device 102 of the first user 116 and simultaneously the transfer of information between the RFID tag or NFC tag 120 is read by the reader 118. In such embodiments, the first user 116 is required to keep their mobile device within close proximity to the system 100 such that the QR code is scanned during or after the reading of the tag 120 by reader 118. In alternative embodiments, the tag QR code may be scanned first and then subsequently the tag 120 is read by reader 118. However, the present general inventive concept is not limited thereto.

In alternative embodiments, a time window feature of the system may be used. In such instances, for example, a package is expected to be delivered on a specific day and time, or a service representative is scheduled to arrive on a specific day and time. In such embodiments, system 100 is configured to establish a communication channel 114 only when the QR code is scanned during the time window for the expected package delivery or service representative arrival. In still other alternative embodiments, the system 100 is configured to establish a communication channel 114 only when the QR code is scanned during the time window along with the mobile device of the first user being in close proximity to the system 100 such that the QR code is scanned before, contemporaneously with, or after the reading of the tag 120 by a reader. That is, the proximity reading and the scanning of the QR take place during the time window. However, the present general inventive concept is not limited thereto.

Although the exemplary embodiments may be described as used in connection with houses, homes, dwellings, and other personal residences, the exemplary embodiments may be used in connection with commercial structures as well, such as, but not limited to, hotels, office buildings, stores and store fronts, hospitals, doctor's offices, schools or other academic institutions, as well as others.

Although a few exemplary embodiments of the present general inventive concept have been illustrated and described, it will be appreciated by those skilled in the art that changes may be made in these exemplary arrangements, embodiments, and methods, and further combination of the method steps as well as the features and relationships of the various arrangements, embodiments, and methods may be made without departing from the principles and spirit of the general inventive concept, the scope of which is defined in the appended claims and their equivalents.

What is claimed is:

1. A method of authenticating a user to provide communication between mobile devices, the method comprising:
affixing a QR code to a fixed location;
scanning, using a first mobile device corresponding to a first user, the QR code affixed to the location;
in response to scanning of the QR code, sending, using the first mobile device, a communication request to a second mobile device corresponding to a second user via a network; and
selectively authenticating, using the second mobile device, the first mobile device for communication.

2. The method of claim 1, further comprising affixing at least one of an RFID reader or an RFID tag to the fixed location.

3. The method of claim 2, wherein the first mobile device includes the other of the RFID reader and RFID tag, and the method further comprising:
scanning, using the RFID reader, a unique identifier associated with the RFID tag,
in response to scanning of the unique identifier, sending, using the first mobile device the communication request to the second mobile device.

4. The method of claim 3, wherein the RFID reader and the RFID tag are configured to communicate via near field communication.

5. The method of claim 4, wherein the communication between the first mobile device and the second mobile device comprises at least one of an audio call, a video call, or messaging.

6. The method of claim 5, further comprising: masking identifying data associated with at least one of the first mobile device and the second mobile device.

7. The method of claim 6, further comprising: subsequent to sending of the communication request from the first mobile device to the second mobile device, enabling the second mobile device to deny the communication request such that the first mobile device is not authenticated for communication.

8. The method of claim 1, wherein the communication between the first mobile device and the second mobile device is established using a smart device software application accessible via at least one of the first mobile device and the second mobile device.

9. The method of claim 2, wherein the first mobile device includes the other of the RFID reader and RFID tag, and the method further comprising:
scanning, using the RFID reader, a unique identifier associated with the RFID tag contemporaneously with the scanning of the QR code, and
in response to the contemporaneous scanning of the unique identifier and the QR code, sending, using the first mobile device the communication request to the second mobile device.

10. A method of authenticating a user to provide communication between mobile devices, the method comprising:
affixing an identifying means to a specific location;
scanning, using a first mobile device corresponding to a first user, the identifying means affixed to the location;
in response to scanning of the identifying means, sending, using the first mobile device a communication request to a second mobile device corresponding to a second user via a network; and
selectively authenticating, using the second mobile device, the first mobile device for communication.

11. The method of claim 9, wherein the identifying means comprises at least one of a QR code, an RFID tag, or RFID reader.

12. The method of claim 10, wherein the first mobile device includes at least one scanning device comprising at least one of a camera, an RFID tag, or RFID reader.

13. The method of claim 9, wherein the communication between the first mobile device and the second mobile device comprises at least one of an audio call, a video call, or messaging.

14. The method of claim 9, further comprising: masking identifying data associated with at least one of the first mobile device and the second mobile device.

15. The method of claim 9, wherein the communication between the first mobile device and the second mobile device is established using a smart device software application accessible via at least one of the first mobile device and the second mobile device.

16. A system for authenticating a user to provide communication between mobile devices, comprising:
an identifying means in operative connection with a fixed location;
a first mobile device corresponding to a first user, wherein the first mobile device is configured to scan the identifying means;
a second mobile device corresponding to a second user, wherein the second mobile device is configured to accept or deny communications from the first mobile device;
wherein responsive to scanning the identifying means, the first mobile device is configured to send a communication request to the second mobile device via a network; and
wherein responsive to receipt of the communication request, the second user is enabled to accept or deny the communication request via at least one input to the second mobile device,
wherein the first mobile device is authenticated for communication upon acceptance of the request.

17. The system according to claim 15, wherein the identifying means comprises at least one of a QR code, an RFID tag, or RFID reader.

18. The system according to claim 16, wherein the first mobile device includes at least one scanning device comprising at least one of a camera, an RFID tag or RFID reader.

19. The system according to claim 15, wherein the communication between the first mobile device and the second mobile device comprises at least one of an audio call, a video call, or messaging.

20. The system according to claim 15, wherein at least one of the first mobile device and the second mobile device is configured to mask identifying data associated therewith.
